(19) United States
(12) Patent Application Publication
(10) Pub. No.: US 2013/0052613 A1
(43) Pub. Date: Feb. 28, 2013

(54) Mouth Tray for Teeth Whitening

(71) Applicants: Ramswamy Rangraj Chetiar, Monroe, NY (US); Viswaraj Ramswamy Chettiar, Monroe, NY (US); Bashker Rangaraj Chetiyaar, Monroe, NY (US)

(72) Inventors: Ramswamy Rangraj Chetiar, Monroe, NY (US); Viswaraj Ramswamy Chettiar, Monroe, NY (US); Bashker Rangaraj Chetiyaar, Monroe, NY (US)

(73) Assignee: MAGICSMILE USA, INC., Monroe, NY (US)

(21) Appl. No.: 13/294,110

(22) Filed: Nov. 10, 2011

Related U.S. Application Data
(60) Provisional application No. 61/489,946, filed on May 25, 2011.

(51) Int. Cl. A61C 19/06

(52) U.S. Cl. 433/216

(57) ABSTRACT

The mouth tray for teeth whitening includes a horseshoe-shaped main body made up preferably of a flexible material and anatomically contoured to fit exactly to the upper and lower sets of adult human teeth. The surface of the mouth tray has a plurality of elevated crisscross patterns to keep the whitening agent in place throughout the procedure. Both the ends of the mouth tray have elevated horizontal ridges with reduced elevation towards the interior portion of the mouth tray prevents the seeping and falling of the whitening agent during the process. A predetermined quantity of whitening gel may be prefilled on the mouth tray. The user just needs to attach the prefilled mouth tray to a suitable lighting device and place the mouth tray inside the mouth.

### 2. CROSS-REFERENCE

The present invention claims priority to Provisional Application Ser. No. 61,489,946 filed May 25, 2011, entitled “Mouth Tray for Teeth Whitening”, which is hereby incorporated by reference.

### 3. TECHNICAL FIELD OF THE INVENTION

The present invention relates to a mouth tray customized to individual patient's teeth without the necessity of professional service.

### 4. BACKGROUND OF THE INVENTION

The desire for whiter teeth is considered to be a necessity in today's cosmetically oriented society. To achieve this goal, people have veneers placed over their teeth or have their teeth chemically bleached. A common method for bleaching involves the use of a dental tray that is custom-fitted to a person's teeth and comfortable to wear. One type of customized tray is made from a stone cast of a person's teeth. Another is customized directly using a person's teeth as a template (e.g., “boil-and-bite” trays). Non-customized trays that approximate the shapes and sizes of a variety of users' dental arches have also been used. A dental bleaching composition is placed into the tray and the tray placed over the person's teeth for a desired period of time.

The conventional practice in the prior art is to utilize reusable trays which are made up of plastic material and in the form of accurate U-shaped mouthpiece with an open-ended interior recess adapted to loosely fit over either of the upper or the lower teeth. The tray is formed with regular cross-section and smooth surface finish which precludes a firm seating of the teeth inside a mouthpiece. As a consequence the tray has a tendency to wobble and slide about in the patient's mouth, thus causing a loss of medication, the contamination of the medication with saliva with which it intermixes in the tray, and a very loose contact of the medication with the surfaces of the teeth. Furthermore, other drawbacks include that the mouthpiece would be of inaccurate size, also the user may have to use the same tray over and over, providing inaccurate results and limited hygiene. Hence the efficacy of the treatment is somewhat diminished.

In the view of the foregoing, there is an ongoing need for an improved mouth tray which is flexible and disposable after each use and able to be applied to the teeth by the user himself for accurate fitting around user's own teeth thereby it is securely in place while performing the procedure.

### 5. BRIEF DESCRIPTION OF THE DRAWINGS

FIG. 1 illustrates an isometric view of the mouth tray in accordance with one embodiment of the invention

FIG. 2 illustrates the orthogonal top view of the mouth tray in accordance with one embodiment of the invention

FIG. 3 illustrates the orthogonal bottom view of the mouth tray in accordance with one embodiment of the invention

FIG. 4 illustrates orthogonal front view of the mouth tray in accordance with one embodiment of the invention

FIG. 5 illustrates orthogonal side view of the mouth tray in accordance with one embodiment of the invention

### 6. DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated in set forth only for the purposes of example and that it should not be taken as a limitation in the scope of the present apparatus and method of use.

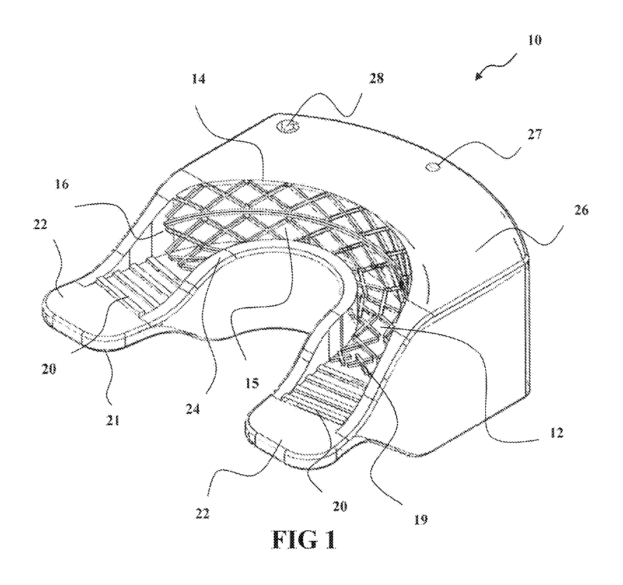

FIG. 1 illustrates an isometric view of the mouth tray in accordance with one embodiment of the invention. The mouth tray 10 according to one embodiment includes a horseshoe-shaped main body made up preferably of a flexible material such as silicone. The mouth tray 10 is anatomically contoured to fit exactly to the upper and lower sets of adult human teeth. The mouth tray 10 has a front-end wall 14 and back-end wall 24 joined to each other by a biting plate 21. All the three surfaces namely front-end wall 14, back-end wall 24 and the biting plate 21 make an interior channeled recess 15. The front-end wall 14 and the biting plate 21 have a plurality of elevated crisscross pattern 19 on their surface as shown in the Figure. The crisscross pattern 19 is provided to match the dentition pattern of a typical human mouth.

The biting plate 21 divides the mouth tray 10 into two symmetrical sections namely upper portion 16 and lower portion 17. The upper portion 16 receives the upper teeth and the lower portion 17 receives the lower teeth. Both the ends of the biting plate 21 have molar edges 22. The molar edges 22 are arranged to sit along and towards the molar or back teeth of the user. The biting plate 21 is provided with horizontal ridges 20 adjacent to the molar edges 22. The height of the horizontal ridges 20 reduces towards the interior channeled recess 15 and prevents the seeping and falling of the whitening agent during the process. The back-end wall 24 is shaped to conveniently place the tongue in between.

In one embodiment, a predetermined quantity of whitening gel may be prefilled inside the interior channeled recess 15 and supplied by the manufacturer. The user just needs to attach the prefilled mouth tray to a suitable lighting device and place the mouth tray 10 inside the mouth. In another embodiment, the mouth tray 10 may be supplied without a whitening gel and can be sterilized and refilled after using once. But one disadvantage of this method is that an inexperienced user may end up adding excessive or small amount of whitening gel that may lead to undesirable results. Hence the preferred method is to supply a prefilled mouth tray 10 and attach it to a suitable lighting device. This will ensure that the procedure is done in accordance with prescribed guidelines from the manufacturer. The whitening gel incorporated in the interior channeled recess 15 is pre-filled before usage and disposed after each use. The flexibility imparted to the mouth tray 10, in contrast to the rigidity of the conventional tray, permits the mouth tray to readily conform to the dentition pattern and adjacent gum structure of the individual's mouth in which it is inserted.

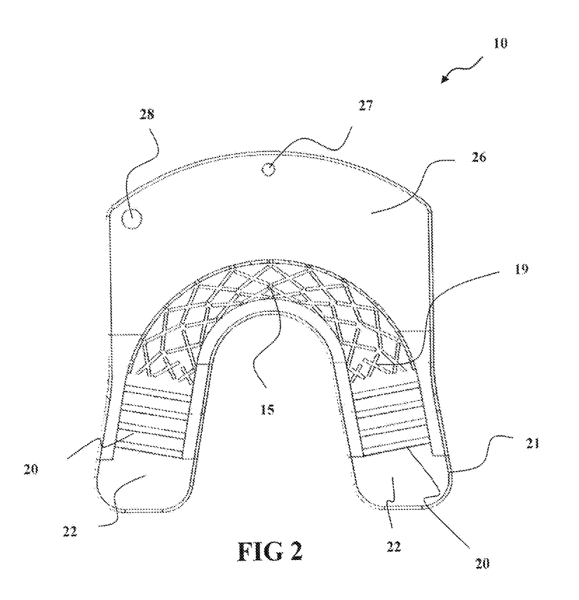

FIG. 2 illustrates an orthogonal top view of the mouth tray in accordance with one embodiment of the invention. The figure shows the upper portion 16 of the mouth tray 10 having crisscross pattern 19 on the surface of the biting plate 21 and horizontal ridges 20 adjacent to the molar edges 22. The upper portion 16 accepts the upper teeth of the user. An extended portion 26 incorporates a slot 27 of suitable size as a fastening means so that it can be attached firmly to a suitable lighting device (not shown). The extended portion 26 also includes an RFID tag 28 to be used in conjunction with a RFID reader (not shown) of the lighting device. The RFID tag 28 may be a 3 mm circular RFID tag and is embedded on the mouth tray 10. The RFID tag 28 is preferably of Low frequency type (134 khz) or High Frequency type (13.56 mhz) Each RFID tag 28 is coded with a unique identifier to distinguish it from other RFID tags. Radio-frequency identification (RFID) uses communication through the use of radio waves to exchange data between the RFID reader and the RFID tag 28 attached to the mouth tray 10 for the purpose of identification and tracking. According to an embodiment of the present invention, a Lighting Device having an RFID reader therein as described in Application entitled “Lighting Device for Teeth Whitening” by Ramswamy Rangraj Chetiar et al. may be used and is being incorporated herein by reference. Upon fitting a new mouth tray 10 to the lighting device, the RFID reader communicates with the RFID tag 28 and decodes the unique identifier associated with it.

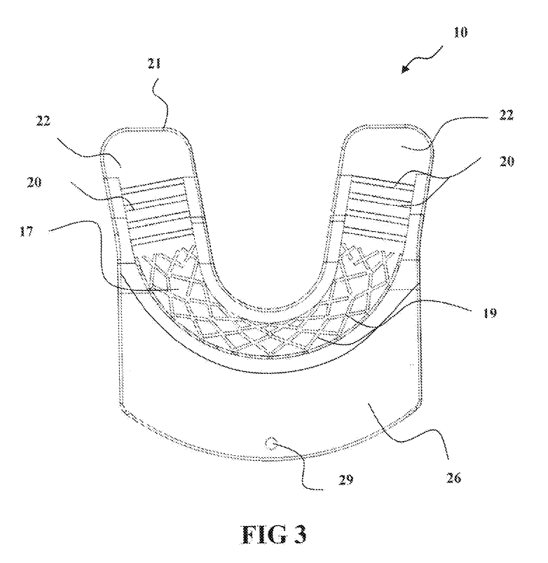

FIG. 3 illustrates an orthogonal bottom view of the mouth tray in accordance with one embodiment of the invention. The figure shows the lower portion 17 of the mouth tray 10 having crisscross pattern 19 on the lower surface of the biting plate 21 and horizontal ridges 20 adjacent to the molar edges 22.

The lower portion 17 of the mouth tray 10 also comprises interior channeled recess 15 having a plurality of elevated crisscross pattern 19 throughout the surface and a plurality of horizontal ridges 20 just before the back end wall 24. The lower portion 17 accepts the lower teeth of the user. The height of the horizontal ridges 20 reduces towards the interior channeled recess 15 and prevents the seeping and falling of the whitening agent during the process. Since the whitening agent tends to reduce in density upon receiving light from a suitable light source to be used in conjunction with the mouth tray 10, the innovative crisscross pattern 19 keeps the whitening agent in place throughout the procedure whereas the horizontal ridges 20 prevent seeping of the excess whitening agent and hence prevent harmful chemicals compositions of the whitening agent from exposure to delicate gum tissues around the teeth. The extended portion 26 is provided with another slot 29 of suitable size on the bottom portion as a fastening means to be attached to a suitable lighting device (not shown).

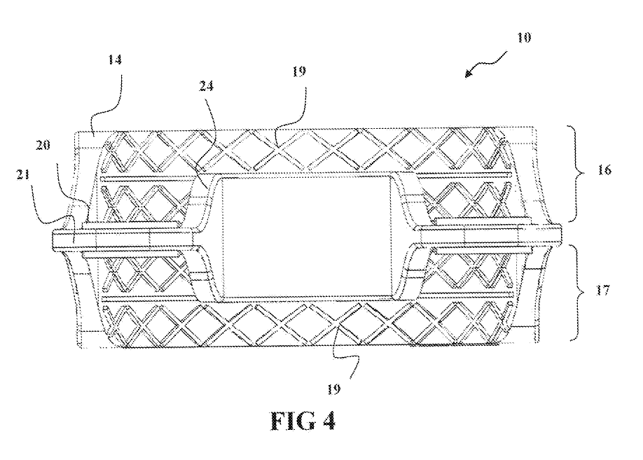

FIG. 4 illustrates an orthogonal front view of the mouth tray in accordance with one embodiment of the invention. The figure shows the upper portion 16 and lower portion 17 of the mouth tray 10 and also shows the elevated crisscross pattern 19 on the front-end wall 14. The biting plate 21 intersects the upper portion 16 and lower portion 17 from the middle. When inserted inside the mouth, the upper portion 16 accepts the upper teeth of the user and the lower portion 17 accepts the lower teeth of the user. The user holds the mouth tray 10 in place against the teeth by biting down on the biting plate 21. The user does not need to hold the mouth tray during the course of treatment.

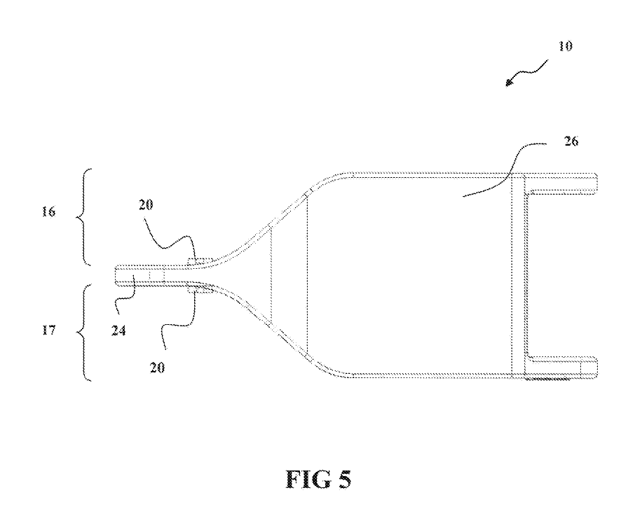

FIG. 5 illustrates orthogonal side view of the mouth tray in accordance with one embodiment of the invention. The horizontal ridges 20 reduce in height towards interior channeled recess 15 of the upper portion 16 and the lower portion 17 of the mouth tray 10. The figure shows the extended portion 26 from where the front portion of a suitable lighting device can be attached to the mouth tray 10 via slots 27 and 29 provided on its upper portion 16 and the lower portion 17 respectively. The mouth tray 10 is attached firmly to the lighting device by bringing it towards the front portion of a suitable lighting device and attaching via fastening means such as slots 27 and 29 provided on the mouth tray 10. The mouth tray 10 attaches firmly to the lighting device due to an additional support provided by the extended portion 26 of the mouth tray 10 and prevent the lighting device from slipping or misalignment during the procedure. Since the mouth tray 10 secures firmly to the lighting device, the patient doesn't need to support the lighting device with his hands. The extended portion 26 also prevents exposure of the light from the lighting device to the areas surrounding patient's mouth including accidental exposure to eyes as well. The seeping and falling of the whitening agent from the corners of the mouth tray during the process is also prevented by the extended portion 26.

The invented mouth tray for the tooth whitening is relatively easy to use, and provides fast and effective treatment over conventional devices. The modified mouth tray provides a better alignment, and a more controlled and uniform treatment. In the context of tooth whitening, for example, the device may require less time for wearing the device, may provide means for treating teeth or a portion of teeth locally, and/or may reduce discomfort associated with whitening agents contacting the teeth for a relatively extended period of time.

1. A mouth tray for teeth whitening, comprising:
a front end wall and a back end wall;
a biting plate connecting the front end wall to the back end wall and receiving a plurality of teeth of a user for performing teeth whitening, wherein the front end wall, the back end wall, and the biting plate form an interior channeled recess; and
the front end wall and the biting plate each comprise a plurality of elevated crisscross patterns on a surface thereof to face the teeth of the user.

2. The mouth tray of claim 1, wherein the mouth tray further comprises:
an upper portion of the front end wall configured to receive upper teeth of the plurality of teeth; and
a lower portion of the front end wall configured to receive lower teeth of the plurality of teeth; and
a plurality of molar edges formed at respective end portions of the biting plate and arranged to sit along and towards molars or back teeth of the plurality of teeth of the user.

3. The mouth tray of claim 2, wherein the biting plate further comprises elevated horizontal ridges formed thereon adjacent to the plurality of molar edges.

4. The mouth tray of claim 3, wherein a height of the elevated horizontal ridges decreases in a direction towards the interior channeled recess.

5. The mouth tray of claim 2, wherein a predetermined amount of whitening gel is prefilled inside the interior channeled recess during a manufacturing process of the mouth tray.

6. The mouth tray of claim 3, wherein the upper portion of the mouth tray comprises the elevated crisscross pattern on the surface of the biting plate and the elevated horizontal ridges adjacent to the molar edges, and the lower portion comprises the elevated crisscross pattern on the surface of the biting plate and the elevated horizontal ridges adjacent to the molar edges.

7. The mouth tray of claim 2, further comprises an extended portion extending from the upper portion and the lower portion in a direction away from the interior channeled recess, wherein the extended portion includes a plurality of slots including at least a first slot formed at an upper surface of the extended portion and a second slot formed at a bottom surface of the extended portion opposite the first slot, and each configured to receive and connect with a lighting device.

8. The mouth tray of claim 6, further comprising:
a radio frequency identification (RFID) tag coded with a unique identifier, and configured to be used for identification and tracking of the mouth tray, wherein the RFID tag communicates using radio waves to exchange data with an RFID reader formed at the lighting device.

9. The mouth tray of claim 8, wherein the unique identifier is decoded and data is exchanged between the RFID reader and the RFID tag upon fitting the mouth tray to the lighting device.

10. The mouth tray of claim 8, wherein the RFID tag is of a low frequency type.

11. The mouth tray of claim 8, wherein the RFID tag is of a high frequency type.

12. The mouth tray of claim 1, wherein the interior channeled recess includes the plurality of elevated crisscross patterns through a surface thereof

13. The mouth tray of claim 2, wherein the upper portion and the lower portion are symmetrical.

14. The mouth tray of claim 1, wherein the mouth tray is horseshoe-shaped and formed of a flexible material.

15. The mouth tray of claim 14, wherein the flexible material comprises silicone.
